(19) United States
(12) Patent Application Publication
(10) Pub. No.: US 2005/0085222 A1
(43) Pub. Date: Apr. 21, 2005

(54) Software updating process for mobile devices

(75) Inventors: Michael Przybilski, Helsinki (FI); Andrei Kotchanov, Espoo (FI); Aapo Rautiainen, Helsinki (FI); Mika Leppinen, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/688,210

(22) Filed: Oct. 17, 2003

(51) Int. Cl. H04M 3/00

(52) U.S. Cl. 455/418

(57) ABSTRACT

This invention describes a block-by-block software updating process for mobile devices using modifications to a memory structure and a start-up process of the mobile device, that are necessary to allow a fail-safe and secure update of the device software. The memory of the mobile device is modified to store a software block currently updated during the software-update, but not overwriting an original block with an updated block before the updated block is verified. This prevents software from entering an unrecoverable inconsistent and nonfunctional state in case of a power loss or a similar problem. Furthermore, the memory modification allows altering a checksum procedure of the mobile device software to prevent any unauthorized modifications of the mobile device software.

### FIELD OF THE INVENTION

This invention generally relates to a software updating process for mobile devices and more specifically to the modifications of a memory structure and a start-up process of the mobile device that are necessary for allowing a fail-safe and secure update of the device software.

### BACKGROUND OF THE INVENTION

In order to update software of a mobile device (mobile phone), it is necessary to install a new version of software to the mobile device. As a previous version of the software already exists on the device, the minimum information that needs to be transferred to the device is a difference between the two versions, which allows the generation of the new software version from the old version. Once this differential information or differential file has been transferred to the device it needs to be merged with the original software version, together forming the new updated software.

Since the original software needs to be overwritten, it is necessary to do this updating process during the boot time of the mobile device, before the software that is to be overwritten is in use.

While the original software is overwritten, the device is in a non-functional and rather critical state. If, during an update process, any problems occur (e.g. power loss), the update cannot proceed and when the problem itself is resolved (e.g. the power is restored), the mobile device software is no longer in a consistent and functional state. That is one problem to overcome. Furthermore, for security reasons, it is necessary to have a procedure in place before starting the software update to prevent any unauthorized modifications of the mobile device software. This is generally accomplished by generating a checksum of the mobile device software and comparing it to a stored checksum before the software itself is started. If the generated checksum will not match the stored checksum, the mobile device will not update the software and perhaps even enter an error state preventing an unauthorized modification of the mobile device-software.

Currently, software updates take place primarily on hardware with a rather high level of resources. For instance, in normal personal computers (PCs), the software is updated while the operating system is running and the new software is stored in a special part of the file system. At a boot time, the file system is made available, and during the boot process, the new software is updated. Such a process is not applicable to the mobile devices for a number of reasons. First, it requires a considerable amount of memory for the storing of new software. Second, in case of a failure during a final update process (the process of overwriting the original software), or during the reboot, the software may enter an inconsistent state where it cannot operate anymore thus, significantly limiting its fault-tolerance. Finally, a PC has less security measures in place compared to a mobile device.

### SUMMARY OF THE INVENTION

The object of the present invention is to provide a novel methodology for a software updating process in mobile devices.

According to a first aspect of the present invention, a method for updating software stored in a memory of a mobile device comprises the steps of: updating a memory block of the memory by merging said memory block with differential information from a differential file stored in the memory; storing the updated memory block in a backup memory area of the memory; determining whether the updated block stored in the backup memory area is correct; and copying the updated block from the backup memory area to an original location, if the updated block is correct. Also further, the software to be updated may be located in a software image area of the memory. Further still, the software to be updated may be located in a variant package area of the memory. Also further still, the differential file may be installed and stored in a user file system area of the memory. Still further, the differential file may be downloaded by the user.

In further accord with the first aspect of the invention, the method further comprises the step of writing a new block status.

Still further according to the first aspect of the invention, the method further comprises the step of checking validity of an update-application stored in the memory, said update-application is used for facilitating said updating. Also, the update-application may be stored in an update-application area of the memory and in a backup area of the memory.

Further still according to the first aspect of the invention, wherein the update-application is valid, and before the step of updating the software, the method further comprises the steps of: checking if the differential file contains data for updating the software, and reading the data for updating the software from the differential file if said data is available. Also still, the method may further comprise the steps of: determining if there is a further block that needs to be updated by identifying a last updated block from a status; and writing new checksums for an updated software if there is no the further block to be updated.

In further accordance with the first aspect of the invention, wherein the update-application is valid, and before the step of updating the software, the method further comprises the steps of: checking if the differential file contains information for updating the update-application; and updating the update-application, verifying it and writing a new checksum for the updated update-application, if the differential file contains information for updating the update-application.

Yet further still according to the first aspect of the invention, checking the validity of the update-application may be verified by comparing a checksum or a backup checksum generated for an update-application stored in an update-application area of the memory or in a backup area of the memory, respectively, with an original checksum stored in the memory to verify that both checksums are identical. Also further, the original checksum may be stored in an update-application checksum area of the memory. Yet still further, wherein the checksum and the original checksum are not identical but the backup checksum and the original checksum are identical, the method may further comprise the step of writing the update-application from the backup area to the update-application area.

According to a second aspect of the invention, a memory of a mobile device comprises: an update-application area for storing an update-application for updating software of the memory; a backup area for temporarily storing the memory block that is updated; and an update-application checksum area for storing the checksum. Also further, the update-application area, the backup area and the update-application checksum area may be located in an update means area of the memory. Yet still further, the memory of a mobile device may further comprise a differential file for updating the software of the memory.

According to a third aspect of the invention, a method for updating software stored in a memory of a mobile device comprises the steps of: checking validity of an update-application stored in the memory; and updating the software using a block-by-block approach based on differential information from a differential file downloaded to and stored in the memory if the update-application is valid, wherein said update is done by overwriting a block with the differential information at a location in the memory that is different from an original memory location of said memory block in the memory, wherein said update-application is used for facilitating said updating.

### BRIEF DESCRIPTION OF THE DRAWINGS

For a better understanding of the nature and objects of the present invention, reference is made to the following detailed description taken in conjunction with the following drawings, in which:

FIG. 1 is a block diagram representing an original memory structure of a mobile device.

FIG. 2 is a block diagram representing a modified memory structure of a mobile device, according to the present invention.

FIG. 3a is a flow chart illustrating a software updating process for mobile devices, according to the present invention.

FIG. 3b is an updating an update-application procedure as an optional part of the flow chart illustrating a software updating process for mobile devices of FIG. 3a, according to the present invention.

### BEST MODE FOR CARRYING OUT THE INVENTION

The invention describes modifications to a memory structure and a start-up process of a mobile device (mobile phone) that are necessary for allowing a fail-safe and secure update of mobile device software.

According to the present invention, the memory of the mobile device is modified to update the software block-by-block (one block at a time) and to store a currently updated software block, thus, minimizing necessary memory resources and preventing phone software from entering an inconsistent and nonfunctional state in the case of a power loss or a similar problem. Furthermore, the memory modification of the memory structure allows altering a checksum procedure of the mobile device software, according to the present invention and as described below, to prevent any unauthorized modifications of the mobile device software.

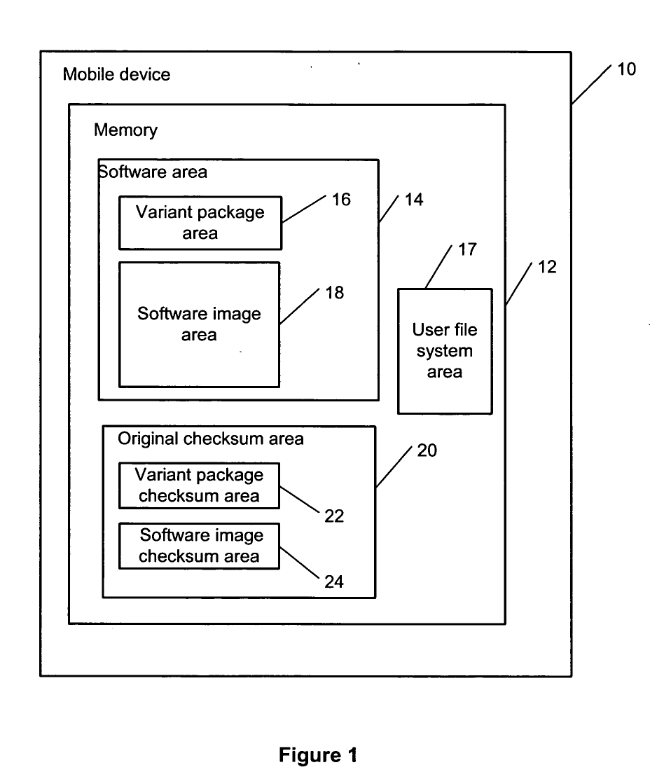

Modification of the memory structure is an important aspect of the present invention. Currently, a typical memory 12 of a mobile device 10 is structured in one possible scenario among others as shown in FIG. 1: a basic software area 14 comprising a software image area 18 for storing the basic application logic and the data, and a variant package area 16 for storing the software variations for a particular language, operator etc.; a checksum area 20 comprising a software image checksum area 24 and a variant package checksum area 22; and a user file system area 17. The file system area 17 typically contains all the data that the user stores on the mobile device 10 including but not limited to entries in his/her phonebook, calendar information, pictures or videos, ringing tones, and even e-mails and office files, etc. The checksum area 20 stores in the area 24 the checksum for the software image and in the area 22 the checksum of the variant package. In the beginning of a startup process, the checksum of the software in the areas 16 and 18 are generated and compared to corresponding checksums stored in the areas 22 and 24. In case these do not match, the mobile device enters an error state, preventing any unauthorized modifications of the mobile device software or the variant package.

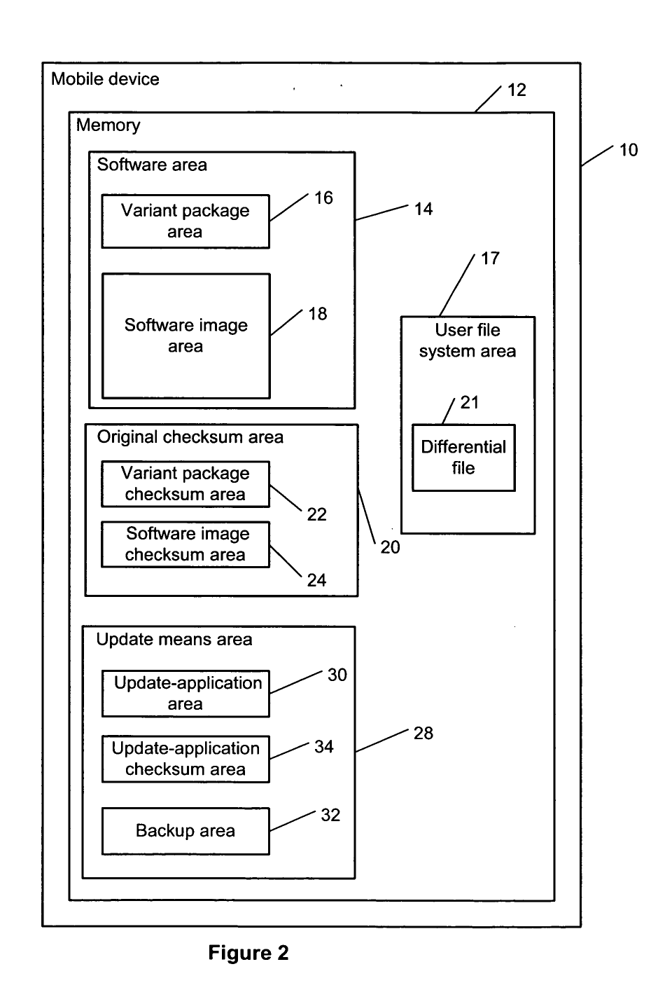

According to the present invention, the memory structure of a typical conventional mobile device 10 shown in FIG. 1 is modified to accommodate an additional memory area, an update means area 28, as shown in FIG. 2. The purpose of introducing the update means area 28 is to facilitate the future updates of the software of the mobile device 10 as described herein. The modifications of FIG. 2 represent only one example among others. The update means area 28 includes an update-application area 30, a backup area 32 and an update-application checksum area 34. The update-application area 30 contains the update-application software that enables updating the software of the mobile device. The update-application is separate software, that primarily contains all the logic and the codes that are necessary for reading data (a memory block) from memory, applying the differential information to it from a differential file 21, storing an updated block first in the backup area 32, checking the validity of the updated memory block in the backup area, and then overwriting the original software block (e.g. in the software area 20). The differential file 21 downloaded, for example, by a phone user or pushed by the phone operator when the software update is needed, is stored in the user file system area 17 and typically contains differential information for memory blocks to be updated, checksums for the complete software 14 before it is updated (to verify, that the differential information is for this software), and checksums of updated blocks. The memory area to be updated using the information in the differential file 21 , generally includes the complete phone memory 1 except for the user file system area 17, a very first block of the memory that contains the first instruction that is being executed by hardware (not shown in FIG. 2), and the backup area 32.

The update-application software can be pre-installed to the areas 30 and 32 during a manufacturing stage of the mobile device 10. The backup area 32 generally is a non-volatile memory area where the update-application temporarily stores a block that is currently updated. The update-application checksum area 34 is introduced in order to also contain the checksum for the update-application. The update-application checksum area 34 is necessary for preventing any unauthorized access to the update-application, according to the present invention.

Altogether, additional memory that is required, according to the present invention, is determined by the size of the update-application, the size of the checksum for the update application and the size of the backup area 32. The backup area 32 needs to be large enough to contain at least either one block of memory that is being updated, or to contain a copy of the update application, in case the update application itself is being updated.

In order to update the mobile device software, two additional steps are being introduced to the process, according to the present invention. After a minimum hardware initialization, the checksum procedure of the update-application is executed and then the software update is executed. This results in the following general steps during the mobile device start-up process as described in the steps below.

1) Minimum hardware initialization is executed (original process).

2) Update-application is checked using the checksum procedure (this is a new step according to the present invention):
a) A checksum of the original update-application, stored in the update-application area 30 is generated and compared to a checksum stored in the update-application checksum area 34;
b) If the checksums are identical, the original update-application is executed;
c) If the checksums are not identical, a checksum for a backup update-application stored in a backup area 32 is generated and compared to the checksum stored in the update-application checksum area 34;
d) If the checksums are identical, the backup update-application is executed;
e) If the checksums are not identical, the mobile device refuses an update and may attempt to continue the normal boot process, or otherwise enters a failure state and the process stops. This can only happen if there is a hardware fault in the phone.

Alternatively, the phone may resume the normal boot process, in which case the regular phone software is verified. In case this succeeds, and only the part of the memory containing the update application and the backup area are broken, the phone may function normally, but an update is not possible until the hardware is fixed. Thus, even this procedure is possible, but it is not recommended.

3) The update-application checks if a software update is intended based on the content of the differential file 21 and does the update (this is also a new step according to the present invention):
a) If an update-software-package contained in the differential file 21 for the mobile device 10 software has been downloaded and stored, the mobile device software is updated as follows:
   i) A status of a possible previous update is checked and, if not completed, a previously interrupted update is continued. (The status is for instance an identification number of the block that was last successfully updated.)
   ii) Memory-block-by-memory-block (one memory block at a time) the mobile device 10 software to be updated is merged with the differential information from the update-software-package of the differential file 21 facilitated by the update-application. Then an updated block is stored in the backup area 32 and verified, by generating a checksum of the updated block, and comparing it to the checksum stored in the differential file. Once a memory block has been updated and verified, the updated block is copied to its original location and the status is updated. In the case of failure, the update process will continue from the last successfully updated block after the mobile device reboots.
   iii) Once all blocks that required an update have been overwritten, the new checksum, which is either contained in the update-package or that is generated, is written into the checksum area 20, thus, providing again a consistency between the mobile device software and the checksum for the mobile device software.
b) If an update-application-update-package has been stored as a part of the differential file 21 in the user file system area 17, the update-application itself can be updated using two alternative procedures i) and ii) below:
   i) If the checksum of the update-application stored in the differential file 21 is identical with the checksum stored in the update-application checksum area 34:
      (A) A new update-application (updated update-application) is generated by merging the original update-application (stored in the update-application area 30) with the differential information from the differential file 21.
      (B) The newly generated update-application is written to the backup area 32 and verified by generating a checksum of the newly generated update-application, and comparing it to the checksum stored in the differential file 21. Once the newly generated update-application has been verified, the old update-application is overwritten with the new one in the update-application area 30.
      (C) Once the update-application software has been updated, the checksum of the new update-application that was previously generated is written to the update-application checksum area 34.
   ii) If the checksum of the update-application stored in the differential file 21 is not identical with the checksum stored in the update-application checksum area 34:
      (A) The checksum of the backup update application (stored in the backup area 32) is checked and if it is the same as in the differential file 21, the backup update application is used to update the original update-application by merging the backup update-application with the differential information from the differential file 21.
      (B) Once the update-application software has been updated and verified as in 3)b)i)(B), the checksum that was previously generated or that is now generated, is written to the update-application checksum area 34, thus bringing update application and update application checksum into a consistent state.

4) The regular boot process continues (original process).

For the process described above, according to the present invention, it is assumed that the writing of a checksum is a transaction (being a non-interruptible, atomic operation). If this is not assumed, it is required that a backup of the checksum be made before the checksum can be overwritten.

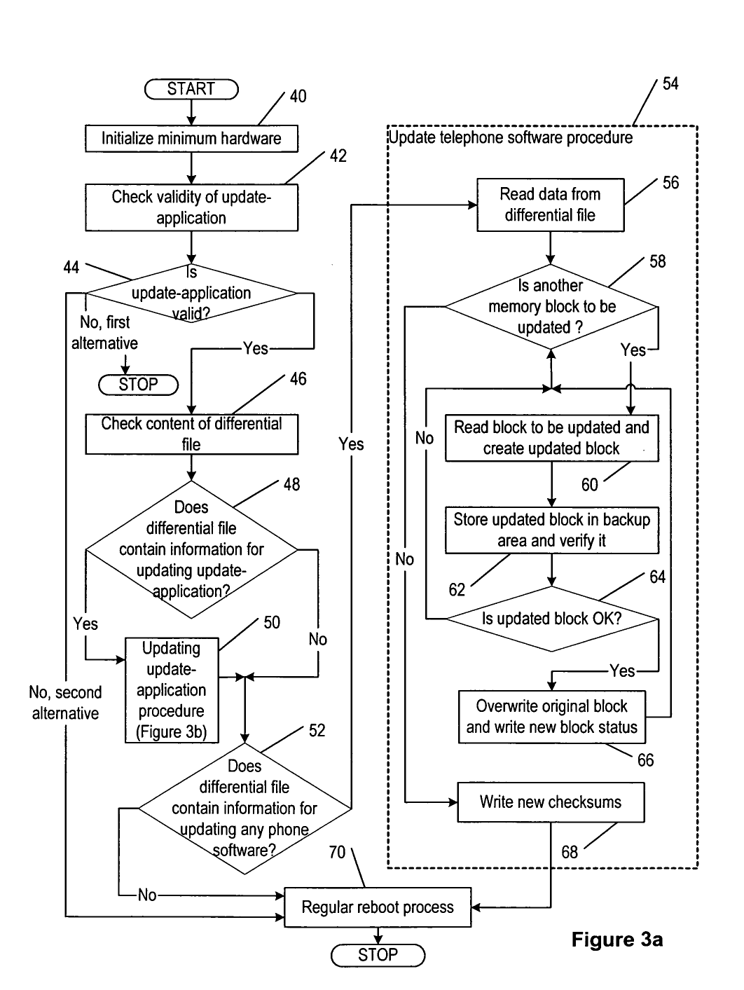

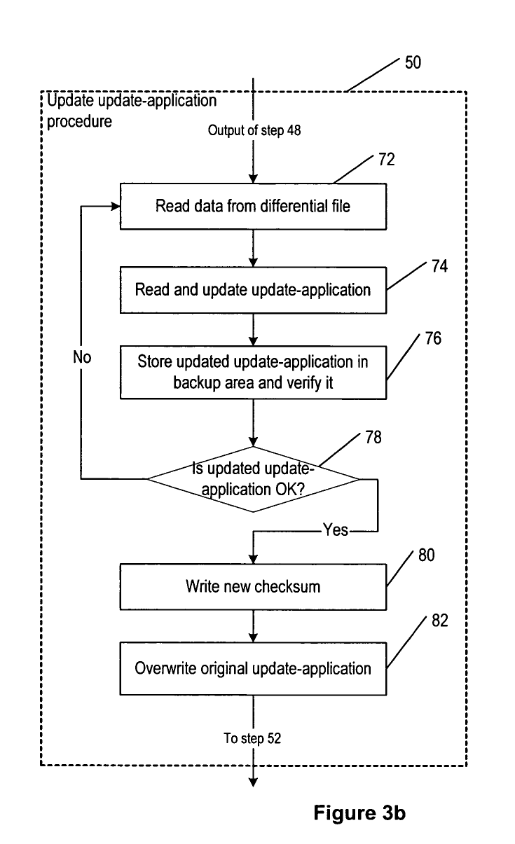

FIG. 3a shows a flow chart illustrating a software updating process for a mobile device 10, according to the present invention. In a method according to the present invention, in one possible scenario among others, in a first step 40, a minimum hardware is initialized. In a next step 42, the validity of the update-application is checked using checksum approach as described above. In a next step 44, it is ascertained if the update-application is valid. As long as that is not the case, there are two alternatives: the process can stop entering a failure state or it can go to a step 70, a regular reboot process. If, however, it is determined that the update-application is valid, in a next step 46, the content of the differential file 21 is checked. In a next step 48, it is ascertained whether the differential file 21 contains information for updating the update-application, i.e. whether the update-application-update-package is contained in the differential file 21. As long as that is the case, the process goes to a procedure 50 for updating the update-application described in details in FIG. 3b, followed by a step 52. If, however, the differential file 21 does not contain information for updating the update-application, in the next step 52, it is ascertained whether the differential file 21 contains information for updating any software stored in the memory 12, which, for example, can include the software stored in the software image area 18 or in the variant package area 16. If in the step 52 it is ascertained that the differential file 21 does not contain the information for updating the software stored in the memory 12, the process goes to the step 70, a regular reboot process. If, however, the differential file 21 contains the information for updating the software stored in the memory 12, in a next step 56, the update information data is read from the differential file 21 and a last updated block is identified from the status. The status can be an identification number of the block that was last successfully updated. There are several implementation alternatives. One possibility is to store the status in a non-volatile memory, once one block has been successfully overwritten with the updated software. Another possibility is to store the checksums of the blocks of the updated software in the differential file 21 and then compare the checksums of each memory block with that of the corresponding block in the differential file 21. The last block that matches is the last block that has been updated. The first one that does not match needs to be updated next.

In a next step 58, it is ascertained whether there is another block to be updated according to the checksum of updated blocks contained in the differential file 21. As long as that is not the case, the process goes to step 68 described below. If, however, there is another block to be updated, in a next step 60, the block to be updated is read (e.g., it is read into the normal executable SDRAM) and an updated block is created using the update-software-package of the differential file 21 and the update-application. In a next step 62, the updated block is stored in the backup area 34 and verified. The verification is done by generating the checksum of the backup area 32, which contains the newly generated block, and comparing it with the checksum of the newly generated block stored in the differential file 21.

In a next step 64, it is ascertained whether the updated block is correct. If the updated block is not correct, the process returns to the step 58 for continuing the updating process for the next block to be updated. If, however, it is found that the updated block is correct, in a next step 66, the updated block is copied to an original location and a new block status is written. After completion of the step 66, the process returns back to the step 58. If in the step 58 it is ascertained that there is no another block to be updated, in a next step 68, the new checksum for the updated software is written in the checksum area 20. And finally, in a next step 70, the regular reboot process is performed.

FIG. 3b shows in one possible scenario the updating update-application procedure 50 as an optional part of a flow chart illustrating a software updating process for the mobile devices of FIG. 3a, according to the present invention. In a step 72, the information contained in the update-application-update-package of the differential file 21 is read and in a step 74, the update-application is updated using the read information from the update-application-update-package. In a next step 76, the updated update-application is stored in the backup area 32 and verified by generating a checksum of the newly generated update-application, and comparing it to the checksum stored in the differential file 21. In a next step 78, it is ascertained whether the updated update-application is correct. As long as that is not the case, the process goes back to step 72 repeating the steps 72 through 78 until the update succeeds. In the step 74, if it is repeated, the updated-application can be read from the update-application area 30 or from the backup area 32. If however, it is determined in the step 78 that the updated update-application is valid, in a next step 80, the new or previously generated checksum is written to the update-application checksum area 34. In a next step 82, the old update-application is overwritten with the updated update-application in the update-application area 30. After completion of the step 82, the process returns to step 52 (see FIG. 3a).

FIGS. 3a and 3b illustrate one example among other possible scenarios for implementing the present invention.

1. A method for updating software stored in a memory (12) of a mobile device (10), comprising the steps of:
updating (60) a memory block of the memory (12) by merging said memory block with differential information from a differential file (21) stored in the memory (12),
storing (62) the updated memory block in a backup memory area (32) of the memory (12),
determining (64) whether the updated block stored in the backup memory area (32) is correct, and
copying (66) the updated block from the backup memory area (32) to an original location, if the updated block is correct:

2. The method of claim 1, wherein if the updated block is correct, further comprising the step of:
writing (66) a new block status.

3. The method of claim 1, wherein the software to be updated is located in a software image area (18) of the memory (12).

4. The method of claim 1, wherein the software to be updated is located in a variant package area (16) of the memory (12).

5. The method of claim 1, wherein the differential file (21) is installed and stored in a user file system area (17) of the memory (12).

6. The method of claim 1, wherein the differential file (21) is downloaded by a user.

7. The method of claim 1, before the step of updating (60) a memory block of the memory (12), further comprising the step of:
checking (42) validity of an update-application stored in the memory (12), said update-application is used for facilitating said updating (60).

8. The method of claim 7, wherein the update-application is stored in an update-application area (30) of the memory (12) and in a backup area (32) of the memory (12).

9. The method of claim 7, wherein the update-application is valid, and before the step of updating (60) the software, further comprising the steps of:
checking (52) if the differential file (21) contains data for updating the software, and
reading (56) the data for updating the software from the differential file (21) if said data is available.

10. The method of claim 9, further comprising the steps of:
determining (58) if there is a further block that needs to be updated by identifying a last updated block from a status, and
writing (68) new checksums for an updated software if there is no the further block to be updated.

11. The method of claim 9, wherein the update-application is valid, and before the step of updating (60) the software, further comprising the steps of:
checking (52) if the differential file (21) contains information for updating the update-application, and
updating (74) the update-application, verifying (76) it and writing (80) a new checksum for the updated update-application, if the differential file (21) contains information for updating the update-application.

12. The method of claim 9, wherein checking (42) the validity of the update-application is verified by comparing a checksum or a backup checksum generated for an update-application stored in an update-application area (30) of the memory (12) or in a backup area (32) of the memory (12), respectively, with an original checksum stored in the memory (12) to verify that both checksums are identical.

13. The method of claim 12, wherein the original checksum is stored in an update-application checksum area (34) of the memory (12).

14. The method of claim 12, wherein the checksum and the original checksum are not identical but the backup checksum and the original checksum are identical, further comprising the step of:
writing the update-application from the backup area (32) to the update-application area (30).

15. A memory (12) of a mobile device (10), comprising:
an update-application area (30) for storing an update-application for updating software of the memory (12);
a backup area (32) for temporarily storing the memory block that is updated; and
an update-application checksum area (34) for storing the checksum.

16. The memory (12) of claim 15, wherein the update-application area (30), the backup area (32) and the update-application checksum area (34) are located in an update means area (28) of the memory (12).

17. The memory (12) of claim 15, further comprising a differential file (21) for updating the software of the memory (12).

18. A method for updating software stored in a memory (12) of a mobile device (10) comprising the steps of:
checking (42) validity of an update-application stored in the memory (12), and
updating (60) the software using a block-by-block approach based on differential information from a differential file (21) downloaded to and stored in the memory (12) if the update-application is valid, wherein said update is done by overwriting a block with the differential information at a location in the memory (12) that is different from an original memory location of said memory block in the memory (12), wherein said update-application is used for facilitating said updating (60).
